(19) United States
(12) Patent Application Publication
(10) Pub. No.: US 2006/0235792 A1
(43) Pub. Date: Oct. 19, 2006

(54) Tracking a fuel cell

(75) Inventor: John P. Janes, Raleigh, NC (US)

Correspondence Address: SCHMEISER, OLSEN & WATTS, 22 CENTURY HILL DRIVE, SUITE 302, LATHAM, NY, 12110, US

(73) Assignee: International Business Machines Corporation, Armonk, NY (US)

(21) Appl. No.: 11/106,294

(22) Filed: Apr. 14, 2005

(51) Int. Cl. G06Q 40/00

(52) U.S. Cl. 705/40

(57) ABSTRACT

A method and system for tracking a fuel cell disposed within a device that has been inserted into an apparatus such that information has been extracted from the inserted device. An identity of the fuel cell is determined from the extracted information. An identity of a registered user of the fuel cell is determined. A current status of the fuel cell of the inserted device is determined. A previous history of the fuel cell is determined from the identity of the fuel cell. A debit or credit to the registered user of the fuel cell is computed in dependence on the determined current status of the fuel cell and on the determined previous history of the fuel cell. The debit or credit is posted to a billing account of the registered user of the fuel cell.

### BACKGROUND OF THE INVENTION

1. Technical Field

The present invention relates to a method and system for tracking a fuel cell.

2. Related Art

A fuel cell is an electrochemical generator in which the chemical energy from the reaction of oxygen and a fuel comprising a hydrocarbon or derivative thereof (e.g., hydrogen) is converted directly into electrical energy such that the fuel cell operates continuously and without need for being replaced so long as fuel and oxygen are available.

The fuel cell may power a small electronic device such as a Personal Digital Assistant (PDA), telephone, barcode reader, MPS player, or video camera. For these devices, the size of the fuel cell may be very small. Since the fuel for the fuel cell is typically hydrogen or a hydrocarbon that is rich in hydrogen, these fuels are combustible and explosive by nature. The small size of the fuel cell combined with the explosive nature of the fuel could make such devices powered by a fuel cell a safety and/or security hazard. Thus, possession of these devices on airplanes, other mass transit systems, and within the grounds of other public places could be restricted due to safety and/or security concerns. Such restrictions on use of fuel cells limit the tracking of fuel cells in such small electronic devices.

### SUMMARY OF THE INVENTION

The present invention provides a method for tracking a fuel cell disposed within a device that has been inserted into an apparatus such that information has been extracted from the inserted device, said method comprising:

determining an identity of the fuel cell from the extracted information;

determining an identity of a registered user of the fuel cell;

determining a current status of the fuel cell of the inserted device;

determining a previous history of the fuel cell from the identity of the fuel cell;

computing a debit or credit to the registered user of the fuel cell in dependence on the determined current status of the fuel cell and on the determined previous history of the fuel cell; and

posting the debit or credit to a billing account.

The present invention provides a system comprising an apparatus and a processor adapted to perform a method for tracking a fuel cell disposed within a device that has been inserted into the apparatus such that information has been extracted from the inserted device, said method comprising:

determining an identity of the fuel cell from the extracted information;

determining an identity of a registered user of the fuel cell;

determining a current status of the fuel cell of the inserted device;

determining a previous history of the fuel cell from the identity of the fuel cell;

computing a debit or credit to the registered user of the fuel cell in dependence on the determined current status of the fuel cell and on the determined previous history of the fuel cell; and

posting the debit or credit to a billing account of the registered user of the fuel cell.

The present invention provides a computer program product, comprising a computer usable medium having a computer readable program code embodied therein, said computer readable program code comprising an algorithm adapted to implement a method for tracking a fuel cell disposed within a device that has been inserted into the apparatus such that information has been extracted from the inserted device, said method comprising:

determining an identity of the fuel cell from the extracted information;

determining an identity of a registered user of the fuel cell;

determining a current status of the fuel cell of the inserted device;

determining a previous history of the fuel cell from the identity of the fuel cell;

computing a debit or credit to the registered user of the fuel cell in dependence on the determined current status of the fuel cell and on the determined previous history of the fuel cell; and

posting the debit or credit to a billing account of the registered user of the fuel cell.

The present invention provides a process for deploying computing infrastructure, comprising integrating computer-readable code into a computing system, wherein the code in combination with the computing system is capable of performing a method comprising:

determining an identity of the fuel cell from the extracted information;

determining an identity of a registered user of the fuel cell;

determining a current status of the fuel cell of the inserted device;

determining a previous history of the fuel cell from the identity of the fuel cell;

computing a debit or credit to the registered user of the fuel cell in dependence on the determined current status of the fuel cell and on the determined previous history of the fuel cell; and

posting the debit or credit to a billing account of the registered user of the fuel cell.

The present invention advantageously mitigates the limitations imposed by the related art on the tracking of fuel cells in small electronic devices.

### BRIEF DESCRIPTION OF THE DRAWINGS

FIGS. 1-2 depicts systems for tracking a fuel cell contained within an apparatus, in accordance with embodiment of the present invention.

FIGS. 3A-3B depict an apparatus containing a device, in accordance with embodiment of the present invention

FIG. 4 depicts a device comprising a fuel cell therein, in accordance with embodiment of the present invention.

FIGS. 5-8 are flow charts for tracking a fuel cell included within a device that has been inserted into an apparatus, in accordance with embodiment of the present invention.

FIG. 9 illustrates a computer system used for tracking a fuel cell, in accordance with embodiments of the present invention.

### DETAILED DESCRIPTION OF THE INVENTION

The present invention advantageously mitigates the limitations imposed by the related art on the tracking of fuel cells in small electronic devices (e.g., PDA, telephone, barcode reader, MPS player, video camera, et.), by having a user insert and leave the device in an apparatus at an airport, mass transit terminal, or on the grounds of other public places where there are safety an/or security concerns. The present invention advantageously provides a method and system that tracks the fuel cell that is within the device that is inserted in the apparatus.

The scope of the present invention generally includes having the apparatus be present at any location where the fuel cell can be tracked including, inter alia, at an airport, mass transit terminal, or on the grounds of other public places where there are safety an/or security concerns.

Thus, the present invention enables a user to exchange a current device for pickup at a later time, pick up a similar device at a later place, turn a device in for credit or refuel a device, etc., by placing the fuel cell containing device into an apparatus that tracks and processes the device and the fuel cell. The present invention includes a method and system for identifying the fuel cell and its user, identifying the amount of fuel remaining in the device, identifying the type of device, refueling the device, defueling the device, communicating with other apparatuses or central computing facility within the network, and accounting for financial accruals to the user's billing account for debits and/or credits resulting from usage of the device and transactions relating to the device.

The present invention includes embodiments in which the user rents the fuel cell and pays a rental fee as well as a fee for fuel consumption for the fuel cell, which are treated as debits to the user. For these embodiments in which the user rents the fuel cell, the user may return the rented device, which is treated as a credit to the user if the user had paid a security fee in conjunction with the rental. Additionally for these embodiments in which the user rents the fuel cell, the user may exchange a fuel cell for another fuel cell if the fuel cell to be exchanged is defective or otherwise undesirable to the user.

The present invention includes embodiments in which the user owns the fuel cell and pays for fuel consumption for the fuel cell, which is treated as a debit to the user.

The present invention includes embodiments in which the user initially purchases the fuel cell from a third party and later turns in the device to the owner of a fuel tracking system, which is treated as a credit to the user.

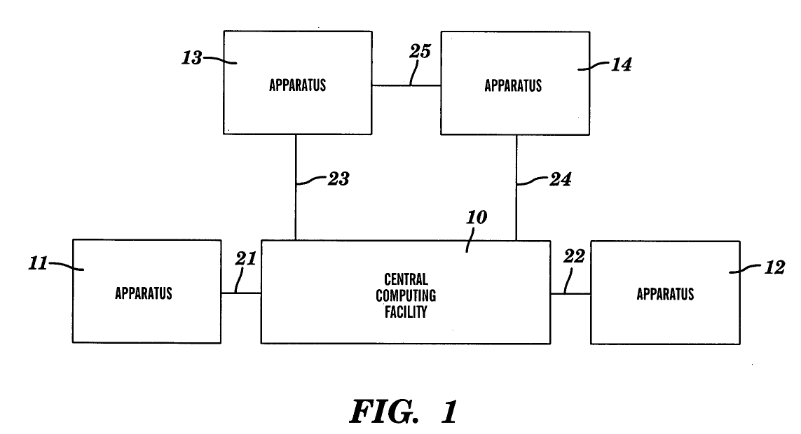

FIGS. 1 depicts a system for tracking a fuel cell contained within an apparatus, in accordance with embodiment of the present invention. The system of FIG. 1 includes a central computing facility 10 and apparatuses 11-14. The apparatuses 11-14 may be located at different physical or geographical sites, or alternatively may be located within a single physical or geographical site. The apparatuses 11-14 may be respectively linked to the central computing facility 10 by communication links 21-24.

In an embodiment, apparatuses 13 and 14 are located on a common site and are linked with each other by communication link 25. In this embodiment, if one apparatus of the apparatuses 13 and 14 should become unavailable (e.g., by malfunctioning), then the other apparatus of the apparatuses 13 and 14 would nevertheless be able to accommodate the users on the common site. In an embodiment in which the apparatuses 13 and 14 are coupled together by the communication link 25, the communication link 23 may be removed or may not exist, so that the apparatus 13 is coupled to the central computing facility 10 through the apparatus 14 and via the communication link 24. If the user has to pay for use of each of the communication link 23 and 24, this embodiment would require only paying for use of the communication link 23.

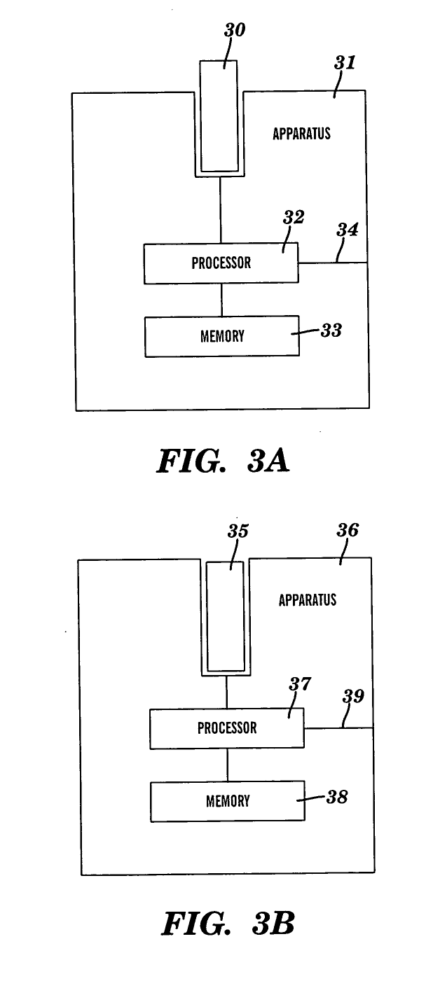

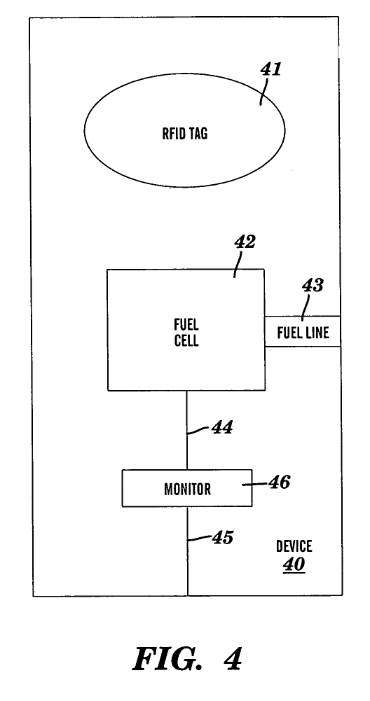

Each apparatus of the apparatuses 11-14 is adapted to receive and process a portable electronic device such as the device 30, 35, and 40 shown in FIGS. 3A, 3B, and 4, respectively, and described infra. While FIG. 1 depicts the four apparatuses 11-14 linked to the central computing facility 10, the present invention generally includes at least one such apparatus linked to the central computing facility 10.

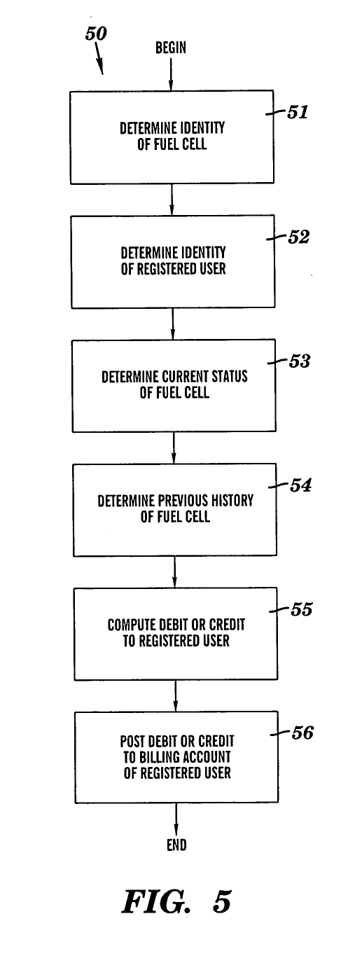

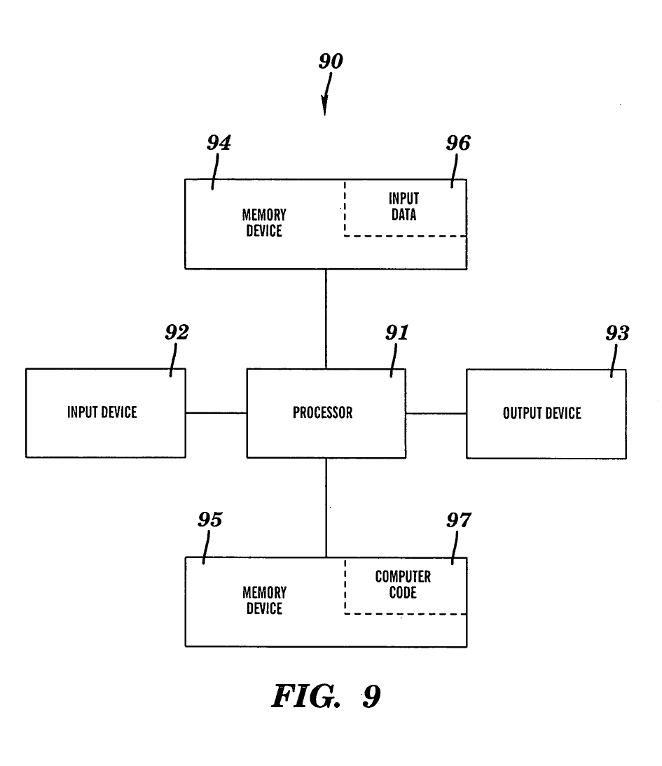

The central computing facility 10 may be represented in more detail by the computer system 90 of FIG. 9 as described infra. The central computing facility 10 has software or computer code that is adapted to perform the algorithms described in FIGS. 5-8 for tracking a fuel cell. A user inserts a fuel-cell containing device into the apparatus 11, 12, 13, or 14. The apparatus identifies the device and/or fuel cell, passes relevant information about the device, fuel cell, and user to the central computing facility 10 which then proceeds to execute the algorithms of FIGS. 5-8. Alternatively, the apparatus itself may comprise the software or computer code that is adapted to perform the algorithms described in FIGS. 5-8 and therefore may execute said software or computer code instead of the central computing facility 10.

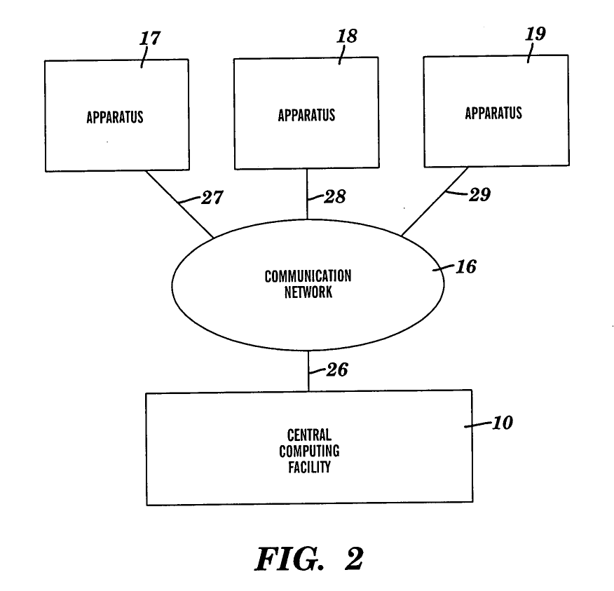

FIG. 1 depicts the apparatuses 11-14 as each being directly linked (such as by electrical wiring, telephone, wireless communication, etc.) to the central computing facility 10 by the communication links 21-24. Alternatively FIG. 2 depicts apparatuses 17-19 respectively linked via communication links 26-29 to the central computing facility 10 by a communication network 16, in accordance with embodiment of the present invention. The communication network 16, which is linked to the central computing facility 10 by the communication link 26, may comprise any communication network or interface known in the art (e.g., Internet, Intranet, Local Area Networks (LAN), Wide Area Networks (WAN), etc.).

Generally for a group of one or more devices, all of said one or more devices may be directly linked to the central computing facility 10 as in FIG. 1, all of said one or more devices may be linked to the central computing facility 10 via a communication network as in FIG. 2, or at least one of said one or more devices may be directly linked to the central computing facility 10 as in FIG. 1 and at least one of said one or more devices may be linked to the central computing facility 10 via a communication network as in FIG. 2.

FIGS. 3A-3B (collectively, “FIG. 3”) depict an apparatus containing a device, in accordance with embodiment of the present invention.

FIG. 3A depicts an apparatus 31 having a device 30 partially inserted therein. A purpose of partial insertion as opposed to full insertion of the device 30 is to permit the user to pull the device 30 out of the apparatus 31 after the device 30 has been processed by the apparatus 31 (e.g., if the user is using the apparatus 31 for refueling the fuel cell 30 or for turning in the fuel cell 30 but not turning in the device 31). The apparatus 31 comprises a processor 32 and a memory 33, wherein the processor 32 is coupled to both the memory 33 and the inserted device 30. The memory 33 is computer-readable memory that may comprise persistent memory (e.g., hard disk memory or optical storage) or non-persistent memory (e.g., random access memory (RAM)) or both persistent and non-persistent memory. The processor 32 is coupled to a communication link (e.g., one of the communication links 21-25 of FIG. 1 or the communication links 27-29 of FIG. 2) via an electrical connection 34. The processor 33 extracts information from the inserted fliel cell 30 and transmits the extracted information to the central computer facility 10 (see FIGS. 1 and 2) via the communication link of FIG. 1 or FIG. 2 that is electrically coupled to the electrical connection 34. The processor 32 may transmit additional information to the central computer facility 10 as derived from additional processing by the processor 33. For example, the processor 32 may obtain, from the memory 33, user information relating to a user of the device 30. Such user information may comprise credit and/or transaction informnation relating to the user.

FIG. 3B depicts an apparatus 36 having a device 35 fully inserted therein. A purpose of full insertion as opposed to partial insertion of the device 35 is to permit the user to turn in the device without recovering the device after the device 35 has been processed by the apparatus 36. The apparatus 36 comprises a processor 37 and a memory 38, wherein the processor 37 is coupled to both the memory 38 and the inserted device 35. The memory 38 computer-readable memory that may comprise persistent memory (e.g., hard disk memory or optical storage) or non-persistent memory (e.g., random access memory (RAM)) or both persistent and non-persistent memory. The processor 37 is coupled to a communication link (e.g., one of the communication links 21-25 of FIG. 1 or the communication links 27-29 of FIG. 2) via an electrical connection 39. The processor 38 extracts information from the inserted fuel cell 35 and transmits the extracted information to the central computer facility 10 (see FIGS. 1 and 2) via the communication link of FIG. 1 or FIG. 2 that is electrically coupled to the electrical connection 39. The processor 37 may transmit additional information to the central computer facility 10 as derived from additional processing by the processor 38. For example, the processor 37 may obtain, from the memory 38, user information relating to a user of the device 35. Such user information may comprise credit and/or transaction information relating to the user.

The apparatuses 31 and 36 of FIG. 3 could be replaced by a single apparatus having multiple openings therein to allow for both partial and full insertion of the device 30 and 35, respectively. Alternatively, a single apparatus allowing for only full insertion of the device 30 or 35 into an opening could have an additional opening therein to allow for ejection of the device 30 or 35 after the device 30 or 35 has been processed by the apparatus.

FIG. 4 depicts a device 40 comprising a fuel cell 42 therein, in accordance with embodiment of the present invention. The device 40 may illustratively be the device 30 or 35 of FIG. 3. The device 40 further comprises a Radio Frequency Identification (RFID) tag 41, a monitor 46, and a fuel line 43.

The RFID tag 41 comprises a microchip and a transmitting antenna, wherein the microchip stores an identification of the device 40 and/or the fuel cell 42 and the transmitting antenna is adapted to transmit said identification of the device 40 and/or the fuel cell 42 to the apparatus (e.g., the apparatus 31 or 36 of FIG. 3) into which the device 40 has been inserted. Alternatively, the device 40 could be identified by other means (e.g., barcode, optical character recognition, etc.) to the apparatus into which the device 40 has been inserted. Identifying the device 40 only may itself facilitate identification of the fuel cell 41, since the particular devices may use corresponding specific fuel cells. Alternatively, the fuel cell 42 may be identified by the monitor 46 as will be explained infra. The RFID tag 41 may be powered by the fuel cell 42 or may be independently powered by a power source within the RFID apparatus (e.g., within the RFID tag 41).

The monitor 46 is coupled to the fuel cell 42 by the electrical connection 44. The monitor 46 monitors characteristics of the fuel cell 42, such as the current amount of fuel disposed within the fuel cell 42, said monitoring being implemented by having the electrical connection 44 electrically coupled to a fuel level/amount indicator circuit (not shown) within the fuel cell 42.

Another characteristic of the fuel cell 42 that may be obtained by the monitor 46 is an identification of the fuel cell and/or the type of type of fuel cell that is represented by the fuel cell 42, as indicated by model number of the fuel cell, manufacturer of the fuel cell, etc., or other identification means. The type of fuel cell may be used, inter alia, to identify the location and size of the mechanical connection to the fuel cell 42 at which the fuel line 43 is interfaced. The type of fuel cell may be used to identify as the type of fuel used by the fuel cell, which facilitates adding fuel to the fuel cell 42 by the apparatus into which the device 40 has been inserted after the amount of fuel required to fill the fuel cell to its capacity is determined as described infra.

The monitor 46 is electrically coupled to the apparatus via the electrical connection 45 for providing access, by the apparatus into which the device 40 has been inserted, to the characteristics of the fuel cell 42 obtained by the monitor 46 and of non-fuel cell characteristics of the device 40 (e.g., the device identification obtained from the RFID tag 41).

FIGS. 5-8 are flow charts for tracking a fuel cell included within a device that has been inserted into an apparatus, in accordance with embodiment of the present invention.

FIG. 5 is a flow chart 50 having steps 51-56 for tracking a fuel cell disposed within a device that has been inserted into an apparatus by a user, or a user's authorized representative or agent, such that information has been extracted by the apparatus from the inserted device. The user inserting the device may be a registered user or the registered user's authorized representative or agent.

Step 51 determines an identity of the fuel cell from the extracted information, such as from information that has been derived from the RFID tag or via other fuel cell identification means described supra.

Step 52 determines the identity of the registered user of the fuel cell contained in the device that has been inserted into the apparatus, such as by, inter alia, having the user enter information into the apparatus. The entered information may comprise, inter alia, a Personal Identification Number (PIN), credit card number, etc. Alternatively, determining the identity of the registered user of the fuel cell may comprise identifying the registered user from the extracted information. For example, the extracted information in step 51 may identify the specific device into which that fuel cell has been inserted, and the owner of the specific device may be recorded in the memory 33 or 38 of the apparatus 31 or 36, respectively, (see FIG. 3), or in a memory device comprised by the central computing facility 10 (see FIGS. 1-2).

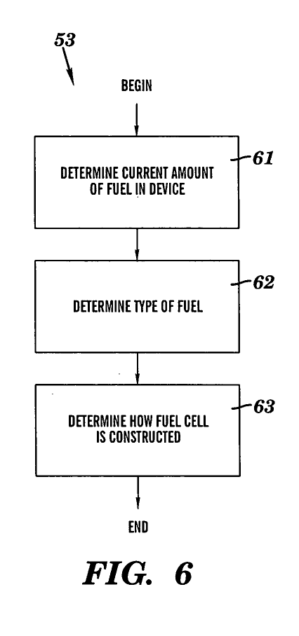

Step 53 determines a current status of the fuel cell of the inserted device, such as by performing at least one the steps 61-63 depicted in FIG. 6. Steps 61-63 of FIG. 6 include: determining an amount of fuel currently within the fuel cell of the inserted device (step 61); determining at least one type of fuel that the fuel cell is adapted to utilize (step 62); and determining how the fuel cell is constructed (step 63). Steps 61-63 of FIG. 6 will be described infra in greater detail.

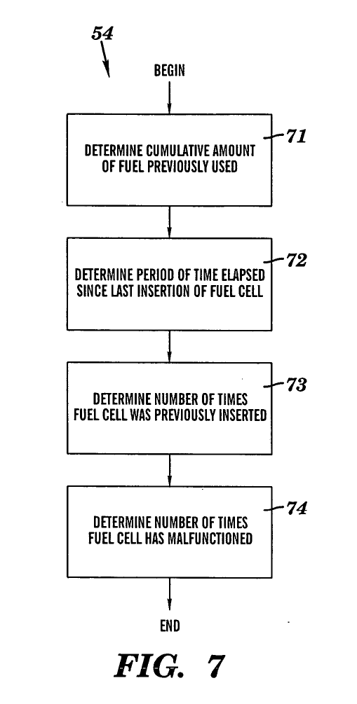

In FIG. 5, step 54 determines a previous history of the fuel cell from the identity of the fuel cell determined in step 51, such as by performing at least one the steps 71-74 depicted in FIG. 7. Steps 71-74 of FIG. 6 include: determining a cumulative amount of fuel previously used by the fuel cell (step 71); determining a period of time elapsed since the last previous time that the fuel cell was inserted into the apparatus or its equivalent (step 72); determining a number of times that the fuel cell has been previously inserted into the apparatus or its equivalent (step 73); and determining a number of times that the fuel cell has been reported as malfunctioning (step 74). Steps 71-74 of FIG. 7 will be described infra in greater detail In FIG. 5, step 55 computes a debit or credit to the registered user of the fuel cell in dependence on the determined current status of the fuel cell (step 53) and on the determined previous history of the fuel cell (step 54). The magnitude of the debit or credit is described inlra for different scenarios in conjunction with the steps of FIGS. 6 and 7.

In FIG. 5, step 56 posts the debit or credit computed in step 55 to a billing account of the registered user of the fuel cell. The billing account of the registered user of the fuel cell may be managed by a third party financial institution such as a bank, billing service, etc. The third party may manage the central computing facility 10 of FIGS. 1-2 or may have its own computing facility.

As stated supra, step 53 of FIG. 5, which determines a current status of the fuel cell of the inserted device, is described in greater detail in steps 61-63 of FIG. 6.

Step 61 of FIG. 6 determines an amount of fuel currently within the fuel cell of the inserted device as described supra. The current amount of fuel can be used for, inter alia: computing an amount of fuel previously used up by the fuel cell and the consequent cost to the registered user for said amount of fuel previously used up by the fuel cell; computing an amount of fuel to be added to the fuel cell to fill the fuel cell to its total fuel capacity; and broadcasting or displaying a low-fuel warning if the current amount of fuel is below a predetermined fuel-amount threshold, etc.

Step 62 of FIG. 6 determines at least one type of fuel (e.g., hydrogen; hydrocarbons such as methane, ethane, propane butane; hydrocarbons having carbon chains between 5 and 12 carbons long, etc.) that the fuel cell is adapted to utilize. The type of fuel may be determined from step 51 of FIG. 5 in which the identity of the fuel cell is determined. Knowledge of the type of fuel facilitates adding fuel to the fuel cell by the apparatus into which the device has been inserted.

Step 63 of FIG. 6 determines the current status of the fuel cell which may comprise determining how the fuel cell is constructed. The type of fuel cell construction may correlate with the type of device (e.g., PDA, telephone, barcode reader, MPS player, video camera, etc.). The type of fuel cell may be useful to, inter alia, identify the location and size of the mechanical connection to the fuel cell at which the fuel line is interfaced as well as the type of fuel used by the fuel cell, which facilitates adding fuel to the fuel cell by the apparatus into which the device has been inserted.

As stated supra, step 55 of FIG. 5, which determines a previous history of the fuel cell from the identity of the fuel cell determined in step 51, is described in greater detail in steps 71-74 of FIG. 7.

Step 71 of FIG. 7 determines a cumulative amount of fuel previously used by the fuel cell from stored data in a database or otherwise in the memory 33 or 38 of FIG. 3 or the memory of the central computing facility 10 of FIGS. 1-2. The amount of fuel previously used by the fuel cell may be cumulated in said database/memory from each determination of the current amount of fuel in the device in step 61 of FIG. 6 during the historical usage of the device.

Step 72 of FIG. 7 determines a period of time elapsed since the last previous time that the fuel cell was inserted into the apparatus or its equivalent. Step 72 assumes that a current date and time may be determined and recorded in storage (e.g., in the memory 33 or 38 of FIG. 3 or the memory of the central computing facility 10 of FIGS. 1-2) for the fuel cell each time the device is inserted into the apparatus 31 and/or 36 of FIG. 3or their equivalent. For example, the apparatus 31 and/or 36 may include a calendar and clock, and/or the central computing facility 10 of FIGS. 1-2 may include a calendar and clock.

Thus, the period of time elapsed since the last previous time that the fuel cell was inserted into the apparatus or its equivalent may be computed by subtracting the time associated with the last previous insertion of the device or its equivalent into an apparatus from the time at which the device has been currently inserted into the apparatus. Since billing dates may be derived from dividing the calendar into billing periods (e.g., monthly billing periods), the period of time elapsed since the last previous time that the fuel cell was inserted into the apparatus or its equivalent may be needed to determine the amount of fuel used in each billing period, in order to calculate the amount to be billed to the registered user for each billing period.

For embodiments in which the user rents the fuel cell and pays a rental fee as well as a fee for fuel consumption for the fuel cell, the rental fee for the current billing period may be a function of the period of time elapsed since the last previous time that the fuel cell was inserted into the apparatus or its equivalent, since the number of days of rental of the fuel cell in the current billing period may be a function of said period of time elapsed since the last previous time that the fuel cell was inserted into the apparatus or its equivalent.

For embodiments in which the user initially purchases the fuel cell from a third party and later turns in the device to the owner of a fuel tracking system by inserting the device into the apparatus, the resultant credit to the user may be a ftunction of the period of time elapsed since the last previous time that the fuel cell was inserted into the apparatus or its equivalent, inasmuch as the age of the fuel cell and its depreciation may be a function of said period of time elapsed. The resultant credit to the user may also be a function of the amount of fuel currently remaining within the fuel cell of the inserted device (from step 61 of FIG. 6) if the remaining fuel was purchased by the registered user from a source other than the third party or was otherwise provided to the fuel cell by the registered user.

Step 73 of FIG. 7 determines a number of times that the fuel cell had been previously inserted into the apparatus or its equivalent, which may be relevant since there may be a manufacturer's limit as to how many time a fuel cell can be refueled.

Step 74 of FIG. 7 determines a number of times that the fuel cell has been reported as malfunctioning, which may be relevant since there may be a predetermined threshold number of fuel cell failures above which the fuel cell should be discarded or sent back sent to the fuel cell manufacturer for repair and/or analysis.

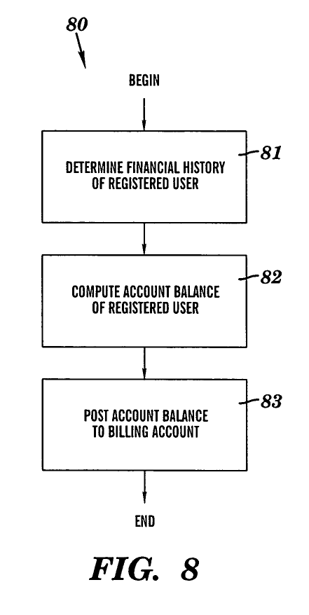

FIG. 8 is a flow chart 80 comprising steps 81-83 which may be performed in addition to the steps in the flow chart of FIG. 5.

Step 81 determines a financial history of the registered user of the fuel cell in relation to the billing account. The financial history of the registered user may include a transaction history of the registered user. The transaction history may comprise the prior insertions of the fuel-cell containing device into the apparatus 31 and/or 36 of FIG. 3 (or their equivalent). The financial history of the registered user may also include actions of the registered user that affect the registered user's financial solvency, financial worth, credit history/rating, or combinations thereof. The determined financial history may comprise some or all of the previous account balances of the registered user.

Step 82 computes an account balance of the registered user of the fuel cell in dependence on the determined financial history (step 81) and on the computed debit or credit (step 55 of FIG. 5). The account balance to be computed depends on the last prior account balance recorded in the financial history of the registered user and on the computed debit or credit to be respectively subtracted from, or added to, the last prior account balance.

Step 83 posts the account balance to the billing account of the registered user.

In an embodiment in which the registered user of the fuel cell is a registered user of at least one other fuel cell, then a history of at the least one other fuel cell is also determined in step 81 and the account balance computation in step 82 is in further dependence on the determined history of the at least one other fuel cell, in reflection of a multiple-use discount to the registered user for using multiple fuel cells.

In some embodiments, the steps of FIGS. 5-8 are performed by software residing in computer-readable memory of the central computing device 10 of FIGS. 1-2 on a processor of the central computing device 10.

In some embodiments, the steps of FIGS. 5-8 are performed by software residing in the computer-readable memory 33 or 38 of FIG. 3 on the processor 32 or 37, respectively.

In some embodiments, the steps of FIGS. 5-8 are performed by any combination of: software residing in computer-readable memory of the central computing device 10 of FIGS. 1-2 on a processor of the central computing device 10; and software residing in the computer-readable memory 33 or 38 of FIG. 3 on the processor 32 or 37.

Thus, the present invention provides a system that comprises a processor and computer-readable memory, said computer-readable memory storing software adapted to perform the steps of FIGS. 5-8, said processor adapted to execute said software, said computer-readable memory comprising at least one of: the computer-readable memory of the central computing device 10 of FIGS. 1-2

FIG. 9 illustrates a computer system 90 used for tracking a fuel cell, in accordance with embodiments of the present invention. The computer system 90 may represent the computer system 10 of FIGS. 1-2. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes the algorithm of FIGS. 5-8 for tracking a fuel cell. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 9) may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Thus the present invention discloses a process for deploying or integrating computing infrastructure, comprising integrating computer-readable code into a computing system, wherein the code in combination with the computer system 90 is capable of performing a method for tracking a fuel cell. The computing system into which the computing infrastructure is deployed or integrated may comprise the computer system 90 as representing the cental computer facility 10 of FIGS. 1-2. Alternatively, the computing system into which the computing infrastructure is deployed or integrated may comprise a computing system disposed within the apparatus 31 or 36 of FIG. 3, said computing system comprising the processor 32 (or 37) and the memory 33 (or 38) of FIG. 3.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for tracking a fuel cell disposed within a device that has been inserted into an apparatus such that information has been extracted from the inserted device, said method comprising:
determining an identity of the fuel cell from the extracted information;
determining an identity of a registered user of the fuel cell;
determining a current status of the fuel cell of the inserted device;
determining a previous history of the fuel cell from the identity of the fuel cell;
computing a debit or credit to the registered user of the fuel cell in dependence on the determined current status of the fuel cell and on the determined previous history of the fuel cell; and
posting the debit or credit to a billing account of the registered user of the fuel cell.

2. The method of claim 1, wherein determining the identity of the registered user results from entry of an identification of the registered user into the apparatus or from identification of the registered user in the extracted information.

3. The method of claim 1, wherein determining the current status of the fuel cell comprises at least one of:
determining an amount of fuel currently within the fuel cell of the inserted device;
determining at least one type of fuel that the fuel cell is adapted to utilize; and
determining how the fuel cell is constructed.

4. The method of claim 1, wherein determining the previous history of the fuel cell comprises at least one of:
determining a cumulative amount of fuel previously used by the fuel cell;
determining a period of time elapsed since the last previous time that the fuel cell was inserted into the apparatus or its equivalent;
determining a number of times that the fuel cell has been previously inserted into the apparatus or its equivalent; and
determining a number of times that the fuel cell has been reported as malfunctioning.

5. The method of claim 1, said method further comprising:
determining a financial history of the registered user of the fuel cell in relation to the billing account, said financial history including a transaction history of the registered user, a credit history of the registered user, or a combinations thereof; and
computing an account balance of the registered user of the fuel cell in dependence on the determined financial history and on the computed debit or credit; and
posting the account balance to the billing account.

6. The method of claim 5, wherein the determined financial history of the registered user includes a transaction history of the registered user, a credit history of the registered user, or a combinations thereof.

7. The method of claim 1, wherein if the registered user of the fuel cell is a registered user of at least one other fuel cell, then the method further comprises determining a history of at the least one other fuel cell and said computing the account balance is in further dependence on the determined history of the at least one other fuel cell.

8. The method of claim 1, wherein determining the identity of the fuel cell, determining the identity of the registered user of the fuel cell, determining the current status of the fuel cell and the previous history of the fuel cell, computing the debit or credit, and posting the debit or credit to the billing account are performed by executing software on at least one of:
a processor disposed within the apparatus; and
a processor located in a central computing facility that is coupled to the apparatus and coupled to at least one other apparatus that is equivalent to said apparatus.

9. The method of claim 1, wherein said computing a debit or credit comprises computing the credit.

10. The method of claim 1, wherein the device comprises a radio frequency identification (RFID) tag, and wherein the extracted information includes information that has been derived from the RFID tag.

11. A system comprising an apparatus and a processor adapted to perform a method for tracking a fuel cell disposed within a device that has been inserted into the apparatus such that information has been extracted from the inserted device, said method comprising:
determining an identity of the fuel cell from the extracted information;
determining an identity of a registered user of the fuel cell;
determining a current status of the fuel cell of the inserted device;
determining a previous history of the fuel cell from the identity of the fuel cell;
computing a debit or credit to the registered user of the fuel cell in dependence on the determined current status of the fuel cell and on the determined previous history of the fuel cell; and
posting the debit or credit to a billing account of the registered user of the fuel cell.

12. The system of claim 11, wherein determining the identity of the registered user results from entry of an identification of the registered user into the apparatus or from identification of the registered user in the extracted information.

13. The system of claimI 11, wherein determining the current status of the fuel cell comprises at least one of:
determining an amount of fuel currently within the fuel cell of the inserted device;
determining at least one type of fuel that the fuel cell is adapted to utilize; and
determining how the fuel cell is constructed.

14. The system of claim 11, wherein determining the previous history of the fuel cell comprises at least one of:
determining a cumulative amount of fuel previously used by the fuel cell;
determining a period of time elapsed since the last previous time that the fuel cell was inserted into the apparatus or its equivalent;
determining a number of times that the fuel cell has been previously inserted into the apparatus or its equivalent; and
determining a number of times that the fuel cell has been reported as malfumctioning.

15. The system of claim 1 1, said method further comprising:
determining a financial history of the registered user of the fuel cell in relation to the billing account, said financial history including a transaction history of the registered user, a credit history of the registered user, or a combinations thereof; and
computing an account balance of the registered user of the fuel cell in dependence on the determined financial history and on the computed debit or credit; and
posting the account balance to the billing account.

16. The system of claim 55, wherein the determined financial history of the registered user includes a transaction history of the registered user, a credit history of the registered user, or a combinations thereof.

17. The system of claim 11, wherein if the registered user of the fuel cell is a registered user of at least one other fuel cell, then the method further comprises determining a history of at the least one other fuel cell and said computing the account balance is in further dependence on the determined history of the at least one other fuel cell.

18. The system of claim 11, wherein determining the identity of the fuel cell, determining the identity of the registered user of the fuel cell, determining the current status of the fuel cell and the previous history of the fuel cell, computing the debit or credit, and posting the debit or credit to the billing account are performed by executing software on at least one of:
a processor disposed within the apparatus; and
a processor located in a central computing facility that is coupled to the apparatus and coupled to at least one other apparatus that is equivalent to said apparatus.

19. The system of claim 11, wherein said computing a debit or credit comprises computing the credit.

20. The system of claim 11, wherein the device comprises a radio frequency identification (RFID) tag, and wherein the extracted information includes information that has been derived from the RFID tag.

21. A computer program product, comprising a computer usable medium having a computer readable program code embodied therein, said computer readable program code comprising an algorithm adapted to implement a method for tracking a fuel cell disposed within a device that has been inserted into the apparatus such that information has been extracted from the inserted device, said method comprising:
determining an identity of the fuel cell from the extracted information;
determining an identity of a registered user of the fuel cell;
determining a current status of the fuel cell of the inserted device;
determining a previous history of the fuel cell from the identity of the fuel cell;
computing a debit or credit to the registered user of the fuel cell in dependence on the determined current status of the fuel cell and on the determined previous history of the fuel cell; and
posting the debit or credit to a billing account of the registered user of the fuel cell.

22. The computer program product of claim 21, wherein determining the identity of the registered user results from entry of an identification of the registered user into the apparatus or from identification of the registered user in the extracted information.

23. The computer program product of claim 21, wherein determining the current status of the fuel cell comprises at least one of:
determining an amount of fuel currently within the fuel cell of the inserted device;
determining at least one type of fuel that the fuel cell is adapted to utilize; and
determining how the fuel cell is constructed.

24. The computer program product of claim 21, wherein determining the previous history of the fuel cell comprises at least one of:
determining a cumulative amount of fuel previously used by the fuel cell;
determining a period of time elapsed since the last previous time that the fuel cell was inserted into the apparatus or its equivalent;
determining a number of times that the fuel cell has been previously inserted into the apparatus or its equivalent; and
determining a number of times that the fuel cell has been reported as malfunctioning.

25. The computer program product of claim 21, said method further comprising:
determining a financial history of the registered user of the fuel cell in relation to the billing account, said financial history including a transaction history of the registered user, a credit history of the registered user, or a combinations thereof; and
computing an account balance of the registered user of the fuel cell in dependence on the determined financial history and on the computed debit or credit; and
posting the account balance to the billing account.

26. The method of claim 25, wherein the determined financial history of the registered user includes a transaction history of the registered user, a credit history of the registered user, or a combinations thereof.

27. The computer program product of claim 21, wherein if the registered user of the fuel cell is a registered user of at least one other fuel cell, then the method further comprises determining a history of at the least one other fuel cell and said computing the account balance is in further dependence on the determined history of the at least one other fuel cell.

28. The computer program product of claim 21, wherein determining the identity of the fuel cell, determining the identity of the registered user of the fuel cell, determining the current status of the fuel cell and the previous history of the fuel cell, computing the debit or credit, and posting the debit or credit to the billing account are performed by executing software on at least one of:
a processor disposed within the apparatus; and
a processor located in a central computing facility that is coupled to the apparatus and coupled to at least one other apparatus that is equivalent to said apparatus.

29. The computer program product of claim 21, wherein said computing a debit or credit comprises computing the credit.

30. The computer program product of claim 21, wherein the device comprises a radio frequency identification (RFID) tag, and wherein the extracted information includes information that has been derived from the RFID tag.

31. A process for deploying computing infrastructure, comprising integrating computer-readable code into a computing system, wherein the code in combination with the computing system is capable of performing a method comprising:
determining an identity of the fuel cell from the extracted information;
determining an identity of a registered user of the fuel cell;
determining a current status of the fuel cell of the inserted device;
determining a previous history of the fuel cell from the identity of the fuel cell;
computing a debit or credit to the registered user of the fuel cell in dependence on the determined current status of the fuel cell and on the determined previous history of the fuel cell; and
posting the debit or credit to a billing account of the registered user of the fuel cell.

32. The process of claim 31, wherein determining the identity of the registered user results from entry of an identification of the registered user into the apparatus or from identification of the registered user in the extracted information.

33. The process of claim 31, wherein deterining the current status of the fuel cell comprises at least one of:
determining an amount of fuel currently within the fuel cell of the inserted device;
determining at least one type of fuel that the fuel cell is adapted to utilize; and
determining how the fuel cell is constructed.

34. The process of claim 31, wherein determining the previous history of the fuel cell comprises at least one of:
determining a cumulative amount of fuel previously used by the fuel cell;
determining a period of time elapsed since the last previous time that the fuel cell was inserted into the apparatus or its equivalent;
determining a number of times that the fuel cell has been previously inserted into the apparatus or its equivalent; and
determining a number of times that the fuel cell has been reported as malfunctioning.

35. The process of claim 31, said method further comprising:
determining a financial history of the registered user of the fuel cell in relation to the billing account, said financial history including a transaction history of the registered user, a credit history of the registered user, or a combinations thereof; and
computing an account balance of the registered user of the fuel cell in dependence on the determined financial history and on the computed debit or credit; and
posting the account balance to the billing account.

36. The method of claim 35, wherein the determined financial history of the registered user includes a transaction history of the registered user, a credit history of the registered user, or a combinations thereof.

37. The process of claim 31, wherein if the registered user of the fuel cell is a registered user of at least one other fuel cell, then the method further comprises determining a history of at the least one other fuel cell and said computing the account balance is in further dependence on the determined history of the at least one other fuel cell.

38. The process of claim 31, wherein determining the identity of the fuel cell, determining the identity of the registered user of the fuel cell, determining the current status of the fuel cell and the previous history of the fuel cell, computing the debit or credit, and posting the debit or credit to the billing account are performed by executing software on at least one of:
a processor disposed within the apparatus; and
a processor located in a central computing facility that is coupled to the apparatus and coupled to at least one other apparatus that is equivalent to said apparatus.

39. The process of claim 31, wherein said computing a debit or credit comprises computing the credit.

40. The process of claim 31, wherein the device comprises a radio frequency identification (RFID) tag, and wherein the extracted information includes information that has been derived from the RFID tag.
